(19) United States
(12) Patent Application Publication
(10) Pub. No.: US 2024/0257280 A1
(43) Pub. Date: Aug. 1, 2024

(54) CREATION OF A BLOCKCHAIN FOR PROPERTY DEVELOPMENT INFORMATION

(71) Applicant: State Farm Mutual Automobile Insurance Company, Bloomington, IL (US)

(72) Inventor: Bryan Nussbaum, Hershey, PA (US)

(21) Appl. No.: 18/427,435

(22) Filed: Jan. 30, 2024

Related U.S. Application Data
(60) Provisional application No. 63/482,176, filed on Jan. 30, 2023.

(51) Int. Cl. G06Q 50/16; G06F 16/2455; H04L 9/00

(52) U.S. Cl. CPC G06Q 50/165; G06F 16/2455; H04L 9/50; G06Q 2220/10

(57) ABSTRACT

An access computing device for creating a blockchain that securely and accurately stores property development information includes a processor in communication with a memory device. The processor is programmed to: (i) access a blockchain network through a first blockchain node computing device, (ii) receive a request for information from a first blockchain of the plurality of blockchains, (iii) transmit a query including an asset identifier to the first blockchain node computing device, (iv) receive an encryption of the property development information from the first blockchain node computing device, (v) access a public key to decrypt the encryption of the property development information, (vi) transmit updated property development information for an existing real estate property asset based at least in part upon the decrypted existing property development information, and (vii) automatically transmit an update instruction to the first blockchain node computing device.

### CROSS-REFERENCE TO RELATED APPLICATIONS

This application claims priority to U.S. Provisional Patent Application No. 63/482,176, filed Jan. 30, 2023, entitled “CREATION OF A BLOCKCHAIN FOR PROPERTY DEVELOPMENT INFORMATION,” the entire contents and disclosures of which are hereby incorporated herein by reference in their entirety.

### FIELD OF THE DISCLOSURE

The present disclosure relates to blockchain technology and, more particularly, to computer-based systems and methods for creating a blockchain that securely and accurately stores property development information for a particular item that may be easily retrieved, viewed and updated by multiple parties.

### BACKGROUND

When building a property (e.g., a home, a building, etc.), a customer may be required to make various decisions regarding the development of the property. For example, the customer may select features of the property (e.g., materials, hardware, appliances, finishing features, etc.) throughout the building process. In at least some cases, the customer may not have access to this property development information, which may lead to errors, inefficiencies, and unnecessary costs.

In addition, after a property is built, the property may be sold to a different user or customer. When considering whether to purchase a property, the customer may consider the history of the property (e.g., status of property systems, age of property and property features, materials used to build the property, etc.). In at least some known systems, the process to store and retrieve information about the property may be a manual process and/or may be spread out over multiple individuals, companies, and/or agencies. In at least some cases, the property's known history may be limited and/or out of date.

Accordingly, the current systems and methods for creating a blockchain that securely and accurately stores property development information may be undesirable for customers, developers, contractors, as well as insurance-providing entities that provide insurance coverage for the property. Conventional techniques may have additional inefficiencies, encumbrances, ineffectiveness, and drawbacks as well.

### BRIEF SUMMARY

The present embodiments may relate to blockchain-based systems and methods for securely and accurately storing property development information, such as for the building and selling of real estate property assets (e.g., a home, a building, etc.). A Property Archival (PA) computer system may include an access computer device and at least one blockchain node computing device of a blockchain network. The access computer device may be associated with a property developer, a property purchaser (“user”), and/or an insurance-providing entity associated with the property. The blockchain network may function as a storage platform for property development information associated with a plurality of real estate property assets, such as homes and buildings. The access computing device may be configured to communicate with the at least one blockchain node computing device to retrieve information from a blockchain associated with a particular real estate property asset and/or to update information stored on the blockchain, such as by adding a new block thereto.

In one aspect, a computer-implemented method of operating a computer system to manage property development information using blockchains may be provided. The method may be implemented by one or more local or remote access computing devices, processors, processors, servers, sensors, transceivers, memory units, mobile devices, wearables, smart glasses, smart watches, augmented reality glasses, virtual reality headset, mixed or extended reality glasses or headsets, voice bots, chat bots, ChatGPT bots, and/or other electronic or electrical components, which may be wired or wireless communication with one another. In one instance, the method may be implemented by an access computing device of the computer system. The method may include: (i) accessing a blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block; (ii) receiving a request for information from a first blockchain of the plurality of blockchains, the request including an asset identifier associated with a real estate property asset; (iii) transmitting a query including the asset identifier to the first blockchain node computing device, the asset identifier identifying the first blockchain and causing the first blockchain node computing device to identify a last block in the first blockchain, the last block including an encryption of property management information for maintenance of an existing real estate property asset; (iv) receiving the encryption of the property development information from the first blockchain node computing device; (v) accessing a public key to decrypt the encryption of the property development information; (vi) transmitting updated property development information for an existing real estate property asset based at least in part upon the decrypted existing property development information, the updated property development information superseding the property development information; (vii) receiving an acceptance notification indicating acceptance of the updated property development information; and/or (viii) in response to said receiving the acceptance notification, automatically transmitting an update instruction to the first blockchain node computing device, the update instruction including the updated property development information, the update instruction causing the first blockchain node computing device to generate and store a new block subsequent to the last block, and the new block including an encryption of the updated property development information and a description of data stored in the last block. The computer-implemented method described herein may include less, additional, and/or alternative functionality, including that described herein.

In another aspect, an access computing device or other computing system for creating a blockchain that securely and accurately stores property development information may be provided. The access computing device or other computer system may include one or more local or remote processors, servers, sensors, transceivers, memory units, mobile devices, wearables, smart glasses, smart watches, augmented reality glasses, virtual reality headset, mixed or extended reality glasses or headsets, voice bots, chat bots, ChatGPT bots, and/or other electronic or electrical components, which may be wired or wireless communication with one another. In one instance, the access computing device may include at least one processor in communication with a memory device. The at least one processor may be programmed to: (i) access a blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block; (ii) receive a request for information from a first blockchain of the plurality of blockchains, the request including an asset identifier associated with a real estate property asset; (iii) transmit a query including the asset identifier to the first blockchain node computing device, the asset identifier identifying the first blockchain and causing the first blockchain node computing device to identify a last block in the first blockchain, the last block including an encryption of property management information for maintenance of an existing real estate property asset; (iv) receive the encryption of the property development information from the first blockchain node computing device; (v) access a public key to decrypt the encryption of the property development information; (vi) transmit updated property development information for an existing real estate property asset based at least in part upon the decrypted existing property development information, the updated property development information superseding the property development information; (vii) receive an acceptance notification indicating acceptance of the updated property development information; and/or (viii) in response to said receiving the acceptance notification, automatically transmit an update instruction to the first blockchain node computing device, the update instruction including the updated property development information, the update instruction causing the first blockchain node computing device to generate and store a new block subsequent to the last block, and the new block including an encryption of the updated property development information and a description of data stored in the last block. The access computing device and/or computer system may include less, additional, and/or alternative functionality, including that described herein.

In yet another aspect, at least one non-transitory computer-readable storage medium having computer-executable instructions embodied thereon may be provided. When executed by a user analytics computing device having at least one processor in communication with at least one memory, the computer-executable instructions may cause the at least one processor to: (i) access a blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block; (ii) receive a request for information from a first blockchain of the plurality of blockchains, the request including an asset identifier associated with a real estate property asset; (iii) transmit a query including the asset identifier to the first blockchain node computing device, the asset identifier identifying the first blockchain and causing the first blockchain node computing device to identify a last block in the first blockchain, the last block including an encryption of property management information for maintenance of an existing real estate property asset; (iv) receive the encryption of the property development information from the first blockchain node computing device; (v) access a public key to decrypt the encryption of the property development information; (vi) transmit updated property development information for an existing real estate property asset based at least in part upon the decrypted existing property development information, the updated property development information superseding the property development information; (vii) receive an acceptance notification indicating acceptance of the updated property development information; and/or (viii) in response to said receiving the acceptance notification, automatically transmit an update instruction to the first blockchain node computing device, the update instruction including the updated property development information, the update instruction causing the first blockchain node computing device to generate and store a new block subsequent to the last block, and the new block including an encryption of the updated property development information and a description of data stored in the last block. The non-transitory computer-readable storage medium described herein may include less, additional, and/or alternative functionality, including that described herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 depicts an exemplary computing environment for implementing a property archival (PA) computer system for creating a blockchain that securely and accurately stores property development information.

FIG. 2 illustrates an exemplary data flow diagram for one aspect of creating a blockchain that securely and accurately stores property development information using the PA computer system shown in FIG. 1.

FIG. 3 illustrates an exemplary data flow diagram for another aspect of creating a blockchain that securely and accurately stores property development information using the PA computer system shown in FIG. 1.

FIG. 4 depicts an exemplary blockchain associated with a real estate property asset that may be generated and stored using a plurality of blockchain nodes.

FIG. 5 illustrates a block diagram of an exemplary blockchain mining system in accordance with one embodiment of the present disclosure.

FIG. 6 illustrates a flow chart of an exemplary computer-implemented process for one aspect of creating a blockchain that securely and accurately stores property development information using the PA computer system shown in FIG. 1.

FIG. 7 illustrates an exemplary configuration of a user computing device that may be used in the PA computer system shown in FIG. 1.

FIG. 8 illustrates an exemplary configuration of a server computing device that may be used in the PA computer system shown in FIG. 1.

FIG. 9 illustrates a diagram of components of one or more exemplary computing devices that may be used in the PA computer system shown in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, systems and methods for creating and maintaining blockchains for securely and accurately storing property development information for a particular item, such that the information on the blockchains may be easily retrieved, viewed, and updated. In one exemplary embodiment, the process may be performed by a master node computer device associated with at least one of a property developer, a property purchaser (“user”), a contractor, and/or an insurance provider associated with the property, also known as an access computer device, in communication with a blockchain network. In the exemplary embodiments, a Property Archival (PA) system, including the access computer device and/or one or more blockchain node computing devices of the blockchain network, may be configured to facilitate automating the blockchain information storage process. The information may be in relation to building and/or selling real estate property assets. The system may be used for the storing and retrieving of development information associated with one or more items. The one or more items may include, but are not limited to, a particular real estate property asset (e.g., features of the property, history of the property, etc.), an assembled device or item (e.g., a vehicle or computer device), and/or any other object that may comprise multiple smaller items and/or pieces. For the purposes of this discussion, an “insurance provider” may refer to any entity that may provide insurance associated with real estate property assets to customers.

As used herein, a blockchain is a distributed database that maintains a continuously-growing list of ordered records, known as blocks. Each block may contain at least a timestamp and a link to the previous block in the chain. The link to the previous block may be a hash of the previous block. For an insurance contract, the first block may contain the initial contract between a consumer and an insurer. The second block may contain a modification to the contract that was requested by the consumer and approved by the insurer. The second block may contain a hashed copy of the first block as well. The third block may contain one or more additional terms for the insurance contract and a hashed copy of the second block. This continues on with each block adding on to the next while containing a hash of the previous blocks in the blockchain.

To ensure the security of the information contained in the blockchain, copies of the blockchain may be distributed across multiple computer devices, known as nodes. These nodes maintain the blockchain, update the blockchain when changes occur, and ensure the stability of the blockchain itself. In some embodiments, nodes may be also used to calculate the hash of the previous blocks. As the blockchain grows, the processing power needed to calculate the hash of the previous blocks grows as well. In these embodiments, the processing of the hash may be distributed over multiple computer devices to improve the speed of processing and/or to not overburden the hashing processor. When a node processes (hashes) a block, that node is known as a miner, where the action of validating and hashing the block is also known as mining.

The PA system described herein may include one or more blockchain node computing devices of a blockchain network, wherein the blockchain network provides an encrypted, distributed, and immutable ledger in which item or property management information associated with a plurality of assets are stored. In some embodiments, the plurality of assets may include real estate assets. In some embodiments, each blockchain node computing device may store a local, complete copy of the ledger as a plurality of blockchains. In other embodiments, a blockchain node may store one or more blockchains of the plurality of blockchains. A blockchain is a distributed database that maintains a continuously-growing list of ordered records, known as blocks. Each blockchain may include a sequence of blocks, wherein each block is cryptographically verifiable and enforces a chronological order of data stored in the subsequent blocks.

In one exemplary embodiment, the plurality of blocks may include a first block representing a first transaction-or registration of property information—associated with a real estate property asset. The plurality of blocks may additionally include subsequent blocks, where each subsequent block after the first block including a cryptographically secured description of data stored in the immediately previous block and/or a link to the previous block. In one exemplary embodiment, each subsequent block in a blockchain may include property information associated with subsequent development and/or sales of the real estate property asset.

In some exemplary embodiments, the description of data stored in the previous block and/or the link to the previous block may include a hash of data stored in the previous block. The hash (which may be referred to as a “hash value”) may be generated by executing a hashing function on the data stored in the previous block. This continues on, with each block adding on to the next while containing a hash of the previous block(s) in the blockchain. In this way, the chronological series of data stored in a single blockchain may be verifiable and immutable. The PA computer system may include and/or access at least one blockchain node computing device, thereby facilitating access to the distributed blockchain network through the at least one blockchain node computing device.

To ensure the security of the information contained in the blockchain, copies of the blockchain may be distributed across multiple computer devices, known as nodes or blockchain node computing devices. These nodes maintain the copies of the blockchain, update the copies of the blockchain when changes occur, and ensure the stability of the blockchain itself. In some embodiments, nodes may be also used to calculate the hash of the previous blocks. As the blockchain grows, the processing power needed to calculate the hash of the previous blocks grows as well. In these embodiments, the processing of the hash may be distributed over multiple computer devices to improve the speed of processing and/or to not overburden the hashing processor. When a node processes (hashes) a block, that node is known as a miner, where the action of validating and hashing the block is also known as mining.

In some embodiments, data stored in a block of a blockchain may be encrypted using any suitable encryption process(es), thereby improving the security of the data stored therein. In some embodiments, a block may include and/or otherwise provide access to a public key that enables decryption of encrypted data stored in the block. In other embodiments, a public key may be securely distributed to access computer device(s) that are verified to have entitlement access to the data within a block and/or within the blockchain network.

In one exemplary embodiment, the blockchain network may function as a platform for storage of property development information associated with real estate property assets. “Real estate property assets” may include, for example, but not limited to, buildings, homes, residences, and/or land developments. The blockchain network may further function to receive and store property development information.

In the exemplary embodiment, the access computing device described herein may be configured to access the blockchain network through a first blockchain node computing device. The access computing device may be further configured to receive (e.g., directly and/or from a user computing device) a request for information from a first blockchain of the plurality of blockchains, the request including an asset identifier associated with a new real estate property asset (e.g., a property being built). The request may be for new property development information.

The access computing device may also be configured to transmit a query including the asset identifier to the first blockchain node computing device, the asset identifier identifying the first blockchain. The query may cause the blockchain node computing device to identify a last block in the first blockchain, wherein the last block includes an encryption of existing property development information associated with an existing real estate property asset (e.g., a property being sold, further developed, repaired, etc.). The access computing device may receive the encryption of the existing property development information from the first blockchain node computing device. In some embodiments, the access computing device may access a public key to decrypt the encryption of the existing property development information. The access computing device may transmit (e.g., to the user computing device, or to a display of the access computing device) updated property development information associated with the existing real estate property asset based at least in part upon the decrypted existing property development information. The updated property development information may be associated with further development, maintenance, and/or repair by a user to the existing real estate property asset and may replace or supersede the existing property development information.

Upon receiving (e.g., from the user computing device or from an input device of the access computing device) a notification indicating a property development update, the access computing device may automatically transmit an update instruction to the first blockchain node computing device. The update instruction may include an encryption of the updated property development information and/or may cause the first blockchain node computing device to encrypt the updated property development information. The update instruction may cause the first blockchain node computing device to generate and store a new block subsequent to the last block, the new block including the encryption of the updated property development information and a description of data stored in the last block (e.g., a hash of the last block).

In some embodiments, when a change to the property development status occurs (e.g., upon the real estate property asset being built, developed, and/or sold), the property development information may be updated. As will be explained further below, the updated property development information may be based upon a blockchain structure. In the exemplary embodiment, the updated property development information includes all of the information about the change to the property development status as well as asset data to link the updated property development information to the first blockchain. In the exemplary embodiment, the updated property development information is transmitted to the first blockchain node computing device for storage and distribution to the plurality of other blockchain node computing devices, to update their local copies of the first blockchain with the updated property development information.

In some embodiments, the property development information as stored by one or more blockchain nodes may be used by the PA computer system to generate and maintain non-fungible tokens (NFTs) of the real estate property asset associated with the stored property development information. The PA computer system may be programmed to: (i) receive a plurality of data associated with the real estate property asset; (ii) generate a container file for the real estate property asset to include the plurality of data; (iii) generate a non-fungible token (NFT) for the real estate property asset based upon the container file; and (iv) store the NFT and the container file for the real estate property asset. The plurality of data associated with the real estate property asset may be data representative of new property development information associated with a new real estate property asset or updated property development information associated with an existing real estate property asset.

As used herein, an NFT (Non-Fungible Token) is a digital asset that represents another object, such as, but not limited to, a real-world object and/or a digital object. The NFT may be generally stored in a blockchain or other cryptographic ledger or register. The NFT may include, but is not limited to, ownership information and a link to a digital asset file that describes, points to, or otherwise indicates the real-world or digital object. NFTs may be traded, sold, exchanged, or otherwise change ownership. The ownership change may be stored on the corresponding blockchain, ledger, and/or register.

The PA computer system may store the plurality of data associated with the real estate property asset as a container file in an electronic ledger, to securely contain the information. The PA computer system may generate an NFT for the real estate property asset based upon the data stored in the container file. The PA computer system may allow subsequent access to the NFT by verified or authorized parties-such as the customer and/or a service provider associated with the real estate property asset. When new or updated information is received and/or incorporated into the container file, the PA computer system may generate an updated NFT to represent the updated real estate property asset data. The updated NFT may be a completely new token, replacing any pre-existing token (while including a hash value of the previous token) or may be an updated version of the pre-existing token, with a hash including an update history of the container file and/or NFT.

The PA computer system may update the container file in response to receiving, retrieving, or assessing additional data associated with the real estate property asset. The PA computer system may in some instances, update the real estate property asset data based upon the additional data (such as updated property development information), and update or overwrite the container file. The NFT may therefore permit continuous, secured, and verified access to data associated with the real estate property asset. Moreover, the NFT remains associated with the real estate property asset regardless of any change in ownership thereof. That is, the NFT includes persistent information associated with the real estate property asset that is owner-agnostic. However, the NFT is also updated (by the PA computer system) to reflect any changes in ownership. More particularly, the NFT will record any ownership change. In some instances, where a real estate property asset is being insured, the real estate property asset's history with a previous owner is recorded and reflected in the NFT, but the PA computer system may import and process data associated with a new or current owner to update the real estate property asset data. For example, a person is interested in purchasing and/or insuring the real estate property asset.

In other embodiments, the PA computer system may use the NFT to generate a virtual recreation of the real estate property asset, such as for use with augmented and/or virtual reality technology. For example, data representative of new property development information or existing property development information may include materials, hardware, and property features used to build and/or develop the real estate property asset. As described further below, augmented and/or virtual reality technology may be used to generate an augmented or virtual recreation of the real estate property asset, such as spaces within the real estate property asset. Additionally, augmented and/or virtual reality technology may be used to generate an augmented or virtual recreation of an event involving real estate property asset, such as events that may impact the insurance coverage of the real estate property asset (e.g., flooding damage, extreme heat, etc.). The PA computer system may be programmed to: (i) retrieve the stored NFT to access the plurality of data associated with the real estate property asset; and (ii) input the plurality of data to an augmented and/or virtual reality technology.

Automating processes for receiving, storing, and maintaining property development information may facilitate improving the accuracy of generating and maintaining development information associated with a real estate property asset, including, for example, but not limited to, the materials, costs, and quantities required for the building, maintenance, and/or repair of property features. “Property features” may include, for example, but not limited to, hardware (e.g., kitchen cabinetry, doors, flooring material, windows, roofing materials, siding, etc.), appliances (e.g., laundry washer, refrigerator, dish washer, dryer, etc.), and finishing features (e.g., surface finishes such as paint and flooring, hardware finishes such as cabinetry knobs and light fixtures, etc.). Additionally, blockchain technology used for the systems and methods as described here may facilitate reducing the costs associated with generating and maintaining property development information. Moreover, the use of blockchain technology may facilitate improving the security of property development information due to the decentralized and encrypted nature of blockchain technology. Broadly, the systems and methods provided herein facilitate improving the accuracy of property development information by orders of magnitude due to automation, thereby reducing the cost to customers as well as providers, while improving data security.

In addition, the substantially seamless property development information transmission between customers, insurance providers, and third parties, facilitated by the distributed computing architecture of the blockchain network, may support improved data communication, such as the automatic transfer of funds and/or documents associated with the real estate property asset. By facilitating the automatic execution and storage (e.g., within the blockchain) of property development information, the systems and methods provided herein may further facilitate the leveraging of stored property development information into additional products and services. For example, in some cases, documents may be validated and stored, and/or purchases associated with property features may be automated, leveraging the blockchain network.

In some embodiments, the PA computer system may include one or more local or remote processors, servers, sensors, transceivers, memory units, mobile devices, wearables, smart glasses, smart watches, augmented reality glasses, virtual reality headset, mixed or extended reality glasses or headsets, voice bots, chat bots, ChatGPT bots, and/or other electronic or electrical components, which may be wired or wireless communication with one another, and/or may be used as data input and output devices. For instance, a combination of a VR headset or AR glasses and voice bots or ChatGPT bots may utilized by a user to collect, input, gather, organize, and/or store information within the PA computer system.

The use of Virtual Reality (VR) and Augmented Reality (AR) for interacting with a 3D objects provides a new interface for using 3D objects in new manners. VR and AR systems allow a user to interact with a 3D virtual environment in a new way compared to traditional interactions using a two-dimensional (2D) display. In VR, a user may be immersed in a virtual environment (e.g., using a VR headset). In other words, a VR device displays images, sounds, etc. to the user in a way that mimics how a user receives sensory stimuli in the real world. In AR, the user may be provided with digital data that overlays objects or environments in the real world (such as via AR glasses). AR devices may use a camera or other input to determine the objects in a user's line of sight and present additional digital data that compliments the real-world environment.

Examples of VR environments may include, but are not limited to, Minecraft® (Minecraft is a registered trademark of Microsoft Corporation, Redmond, Washington), Metaverse, and Second Life® (Second Life is a registered trademark of Linden Lab of San Francisco, CA). These VR environments allow the user to interact with and modify said environments using VR tools, such as by building and creating content including structures and objects.

As described in further detail herein, VR and AR technologies (and/or voice bot technologies, such as Chat GPT) may be utilized to more effectively handle and use 3D objects, such as described herein. In one embodiment, a user interacts with a 3D object using VR. Specifically, the user navigates a virtual environment, applying bounding frames to objects, labeling objects, rotating views, and traversing areas of the virtual environment using a VR device. In other words, the user is immersed in a virtual environment and interacts with the virtual environment through the VR device in order to interact with and/or view the 3D objects. In one embodiment, the virtual environment is a recreation of a real estate property, such as a home. For example, the user may place the 3D features in the home, such as in the same relative place that those 3D features are placed in the real world.

In another embodiment, a user views a real-world environment, and an AR device displays virtual content overlaying the real-world environment. Specifically, if the user is in a geographic location associated with the geographic location of a 3D object, the AR device may overlay the real world environment with virtual objects from the 3D digital environment, allowing the user to interact with the digital environment and digital objects. In one example, a user may view an augmented reality view of their home, where virtual furnishings and/or fixtures are overlain over the current furnishings and/or fixtures to show how changes may look.

As used herein, “VR environment” refers to a digital or virtual environment experienced by or displayed to a user through a VR computing device. In other words, “VR environment” refers to the VR view and functionality experienced by a user through a VR enabled computing device. Conversely, any virtual or digital environment displayed to a user through a VR computing device may be considered a VR environment.

As used herein, “AR environment” refers to a digital or virtual environment overlaid on a real-world environment and experienced by a user through a VR/AR computing device. In other words, “AR environment” refers to the AR display and functionality experienced by a user through an AR enabled computing device.

In some further embodiments, the VR and/or AR may allow for haptic response to allow the user to feel and interact with one or more virtual objects. The haptic response may be provided through the use of gloves or other feedback devices. In one embodiment, the haptic response allows the user to feel the texture and/or weight of the 3D object.

In the exemplary embodiment, the PA computer system is in communication with one or more storage hubs or databanks, that are databases of digital twins. The PA computer system is able to determine which digital twins are associated with an individual policyholder and/or individual policy. The PA computer system generates an inventory of the objects associated with the policyholder or other individual.

The digital twin may be a 3D representation of an object that may be viewed at any angle and may be interacted with in a virtual environment. In the exemplary embodiment, a Non-Fungible Token (NFT) may be generated to log the ownership of the physical object and the corresponding digital twin. In some embodiments, the digital twin may include a link to the NFT that indicates the ownership of the digital twin and/or the physical object itself.

In at least one embodiment, when building a home, one or more of the home buyer, the home designer, the home builder, and/or one or more contractors generate a digital twin or blockchain listing of the decisions and items that went into the home design and/or construction. In one embodiment, when designing the home, the home buyer and/or the home designer make selections about the different items and features that the home buyer wants in their new home. The decisions may include, but are not limited to, fixtures (e.g., faucets, light switches, lighting fixtures, etc.), textures (e.g., carpets, wooden floors, countertops), appliances (e.g., dishwasher, refrigerator, etc.), and/or decorations (e.g., window treatments). These decisions are stored in the blockchain and/or digital twin. These decisions may be linked to actual products.

When the home is constructed, updated, and/or modified, the home builder and/or contractor can consult those decisions via an access computer device. Furthermore, as the home builder and/or contractor installs the items associated with those decisions, the home builder and/or contractor may enter which items were installed. This may include the make and model of the installed items. In some further embodiments, the home builder and/or contractor may also enter the serial numbers of the installed items to be stored by the blockchain and/or digital twin. This allows the consumer to later review the installed items. In some embodiments, the items in the blockchain and/or digital twin may link back to websites, manuals, and/or other external information about the installed items.

In some further embodiments, the consumer is able to view the installed items in virtual reality. In these embodiments, the PA server uses the stored information to place the different items in a 3D representation of the home, allowing the consumer to see the items as they would be in the home.

The virtual representation of the home may also be used to determine upgrades and/or changes to the home. The consumer may load the VR representation of the home and make changes to see how the changes would affect the look and feel of the home. Furthermore, when changes are made to the home, the corresponding blockchain and/or digital twin may be updated as well. The home builder and/or contractor may enter the new items that have been added and/or changed in the home to the corresponding blockchain and/or digital twin. If properly updated, the corresponding blockchain and/or digital twin creates an accurate representation of the contents and make-up of the home. This may be provided to potential purchasers of the home to show the home virtually.

In some embodiments, the homeowner may access the information about the home to determine one or more items needed for the home. For example, the information may include the sizes and types of consumable items in the home, such as, but not limited to, furnace filters, light bulbs, water filters, etc. The homeowner may use that information to purchase needed consumable items for the home. At least some of the information may also be provided to one or more service providers that maintain one or more systems in the home, such as an HVAC service provider.

In the case of a loss or insurance claim, the PA computer system may then be able to determine the items lost, their corresponding value, and their replacement and/or repair costs. In some cases, the digital twin may be inspected and compared to a damaged object to determine what it would take to repair the object, home, and/or portion of the home. In some further embodiment, the digital twin may be used to create one or more files that may be used to 3D print or otherwise create a replacement object, and/or provide parts to repair the object and/or home.

In additional embodiments, objects may also be cataloged through reviewing the individual's purchase history from apps, bank statements, receipts, or other linked programs or stores. Transactions related to rare or valuable items may be recorded as NFTs, assigned ownership, and may become a part of a ‘bank’ or inventory of objects in the individual's possession.

In some further embodiments, the individual's inventory may be used in a virtual reality environment. In this virtual reality environment, the individual may use the digital twins of their objects in their virtual reality surroundings. For example, an individual may recreate a virtual version of their home (or other structure) in the virtual reality. Then the individual may add the digital twins of the items that they own to the virtual home. In this way the individual may create a complete digital twin of their home or other structure.

The virtual reality home may then be used and/or toured by others. In this example, the individual may recreate a home, such as the one that they grew up in or a specific family member's home. For instance, the individual may be a grandparent and recreate their home so that they may invite others over virtually for a virtual family meal or activity. By having the recreated virtual environs, the activity may occur in known settings. In another instance, prospective home buyers may be able to virtually tour the home. In a further instance, service providers may view the virtual representation of the home to determine which items may be needed for a service call. A home builder and/or contractor may view the virtual representation of the home to determine how to make additions, changes, and/or repairs, and what materials and/or tools may be needed for those additions, changes, and/or repairs. These individuals may be able to host others in a virtual gathering and move around and interact with the virtual surroundings.

In some embodiments, the virtual structure recreation may be used for insurance purposes. A 3D scan may be taken of each room of the structure to create a digital twin of the structure. Then each room may be populated with objects scanned and/or entered by the user. For example, a digital twin of a home may be populated with digital twins of the physical objects that are in the physical home. The digital twin objects may be used to create a list and/or virtual inventory of the physical objects that are in the physical home.

In the case of a loss and/or insurance event, the inventory may be consulted to determine which objects were in the home. The virtual home and virtual objects may also be inspected by underwriters and/or other individuals associated with the insurance provider to catalog each item and determine an insurance value in case of damage and/or loss. Furthermore, the virtual home and/or digital twin objects may also be inspected after a loss and/or insurance event, such as a fire. This would allow claim processors to inspect the original, insured condition of the total loss items.

The virtual structure may include, but is not limited to, homes (including current, past, future, and dream), businesses (including current, past, future, and dream), and other structures (including small structures such as sheds and/or tree homes or large structures such as monuments and museums). The structures may be recreations of structures that are no longer available, such as a home that had previously burned down or been sold. The structures may also be recreations of currently existing structures, such as the user's current home or business. The structures may also be recreations of future or dreamed for structures. These may include structures that are being built and/or remodeled, structures that have been purchased but not yet inhabited or used, or structures that are being considered for purchase. The user may populate these virtual structures with digital objects, such as the digital twins, to recreate or to see how the objects would fit in other structures.

This could also be done at a shopping retail location, such as an antique store or other store that includes unique and/or rare items. Rather than allowing individuals to handle the physical items, the individuals may view and inspect the digital twins of the items that they are interested in. This may allow each individual to visit shops in different locations without having to travel to the physical location. While many websites allow individuals to view objects for sale, those views are generally two dimensional images that may make it difficult to judge the relative size and other aspects of the object. The 3D scans that create the digital twin would provide additional detail. Furthermore, in the case of jewelry and/or other wearable items, the individual may be able to virtually try on the object. In an additional embodiment, the potential buyer may be able to rent or acquire (permanently or temporarily) the digital twin of the object and then see how the object would look in their virtual home. When an individual purchases one of the digital twins and the corresponding physical object, the NFT associated with the digital twin may be updated to show the change in ownership. The information about the digital twin and the NFT may be transmitted to an insurance provider computer device for the insurance provider to insure the object.

At some point, a hacker may gain access to the individual's digital environment and damage the digital twin. The individual may recreate the digital twin from the bank or database of the insurance provider (or other entity).

In this example, the individual's home is destroyed, and all of the family heirlooms and documents are destroyed. The NFTs are still stored in the database and/or digital bank. The individual may continue to view the digital versions of the heirlooms and/or the home. The individual may determine whether or not to duplicate the heirlooms, documents, and/or pictures, such a through 3D printing or other manufacturing. The individual may either interact with the virtual versions and/or the recreated physical versions.

In additional embodiments, the inventory may be supplemented with additional information, such as information from one or more smart home devices in the policyholder's residence. In this embodiment, the PA server may determine which components where connected to the smart home system, such as, but not limited to, smart locks, furnaces, air conditioners, thermostats, light bulbs, televisions, appliances, sensors, and any other device or processor, run through the smart home device, such as through a smart home hub.

In another embodiment, the PA server may receive information about the devices connected to the Wi-Fi network at the user's or policyholder's residence. In this example, the PA server may receive message traffic data, log data, or other data that allows the PA server to identify the devices that are connected to the policyholder's network. These devices may include mobile devices, laptops, desktops, tablets, smartphones, IP cameras, smart refrigerators, smart stoves, and/or other wireless connected devices. The PA server may be able to determine a make and model associated with each electronic device that is connected to the network, such as by PINs, identification numbers, and/or manufacturer numbers.

In another example, the PA server receives data from computer devices associated with one or more retailers to determine household goods that the policyholder has purchased. The PA server may use the data to determine the purchases made by the policyholder over various periods of time. This data may include makes, models, and/or quantities of household goods purchased by the policyholder.

In yet another example, the policyholder may take video and/or pictures of their home and possessions to show what is currently owned and kept in the home. The video and/or pictures may then be transmitted to the PA server to assist in generating the index. The PA server may then, for example, run pattern recognition, object recognition, optical character recognition, or other machine learning techniques to identify goods, and current quality, quantity, or status of the goods. The PA server may also use the video and/or pictures to determine where in the home different objects are located and associate the digital twins with that location in a virtual home for the individual.

The policyholder may also prepare lists of their possessions, such as manually and/or by using their mobile device and image analysis. These possessions may include household goods associated with, or owned by, the policyholder. The PA server may use any of these above methods to determine additional objects that are associated with or owned by the individual/policyholder. For example, the individual/policy holder may indicate that they own a particular model of a gaming console. Rather than having the individual/policy holder 3D scan the gaming console, the PA server may access a previous scan/digital twin of the gaming console model and create a copy of the digital twin of that gaming console for the individual/policyholder. The PA server may then create an NFT for the gaming console model indicating that the individual/policyholder is the owner of that model of gaming console.

These lists and inventories may be extremely valuable before a loss occurs, as it may be hard for the policyholder to remember everything contained in a home. In addition, performing this inventory prior to a loss may help to prevent the policyholder from listing items as lost that the policyholder didn't own. These inventory listings of 3D objects are also important for determining the replacement value and the depreciated value of the reported lost items, and/or facilitating more accurate risk assessment and claim handling.

In addition, the user or policyholder may determine their replacement preferences in the case of a loss. The user or policyholder may list their replacement preferences for when a loss occurs, to be stored by the PA server and/or their mobile device. For example, the user or policyholder may determine that he would want to replace a lost dining room set with the exact same set, if the original set was lost or damaged, such as in a fire. The user or policyholder may also decide to recreate a lost artifact or other unique object using the 3D scan of the object associated with the NFT.

An event may occur that causes a loss for the policyholder or other user. This event could be any event that results in a loss for the policyholder that causes the policyholder to submit a claim. For example, the event may be a fire or storm damage to the policyholder's home. This event may cause the policyholder to lose their residence and have to move to another address, either permanently or temporarily. In another example, the loss could be a partial loss. For example, either where the policyholder's home is only partially damaged, or where the policyholder's vehicle was broken into, and several items were taken out of the vehicle.

When a claim is initially processed, the PA server may create a claim fund based upon the policy and the items lost. The PA server may adjust the claim fund based upon the items lost, the availability of direct replacements, the replacement costs for items lost, and/or the depreciation associated with the lost items.

The systems and methods described herein provide for supporting insurance, recovery, and cyber-protection of real-world, digital twin, and native digital assets. The systems and methods described herein may also provide for methods for making underwriting and claims processing be more efficient through the use of 3D indexing valuable and unique items so that they may be inspected to provide with an insurance value, cataloged, and replaced after a total loss event.

The systems and methods described herein may further provide for claims processors to inspect the original, insured condition of total loss items. In addition, the systems and methods described herein may provide methodologies to insure digital assets and assign ownership and possession of items using NFTs for insurance purposes. Moreover, the systems and methods described herein may provide methodologies to catalog and assign ownership of items purchased online or through a virtual reality environment, such as avatars, buildings, and/or skins, for example, and to store these digital objects in a secure environment, such as a secure digital bank. Furthermore, the systems and methods described herein may provide methodologies to track physical and digital possession and transfer of ownership via NFTs. Finally, the systems and methods described herein may provide methodologies to create exact match replacements of rare, one-of-a-kind items through 3D indexing scans and 3D printing.

At least one of the technical problems addressed by this system may include: (i) improving the accuracy of development information associated with real estate property assets; (ii) allowing for automatic updates to a property development “ledger” on a blockchain platform; (iii) improving the online security of stored property development information through the blockchain technology; (iv) reducing timeline and costs associated with maintaining and modifying property development information; and/or (v) improving accessibility of property development information while eliminating the need for third-party information providers.

The methods and systems described herein may be implemented using computer programming or engineering techniques including computer software, firmware, hardware, or any combination or subset thereof, wherein the technical effects may be achieved by performing at least one of the following steps: (a) accessing a blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block; (b) receiving a request for information from a first blockchain of the plurality of blockchains, the request including an asset identifier associated with a real estate property asset; (c) transmitting a query including the asset identifier to the first blockchain node computing device, the asset identifier identifying the first blockchain and causing the blockchain node computing device to identify a last block in the first blockchain, the last block including an encryption of existing property development information for a build and/or development of an existing real estate property asset; (d) receiving the encryption of the existing property development information from the first blockchain node computing device; (e) accessing a public key to decrypt the encryption of the existing property development information; (f) transmitting updated property development information for an existing real estate property asset based at least in part upon the decrypted existing property development information, the updated property development information superseding the existing property development information; (g) receiving an acceptance notification indicating acceptance of the updated property development information; and/or (h) in response to said receiving the acceptance notification, automatically transmitting an update instruction to the first blockchain node computing device, the update instruction including the updated property development information, the update instruction causing the first blockchain node computing device to generate and store a new block subsequent to the last block, the new block including an encryption of the updated property development information and a description of data stored in the last block.

### Exemplary Property Archival System for Managing Property Development Information Using Blockchains

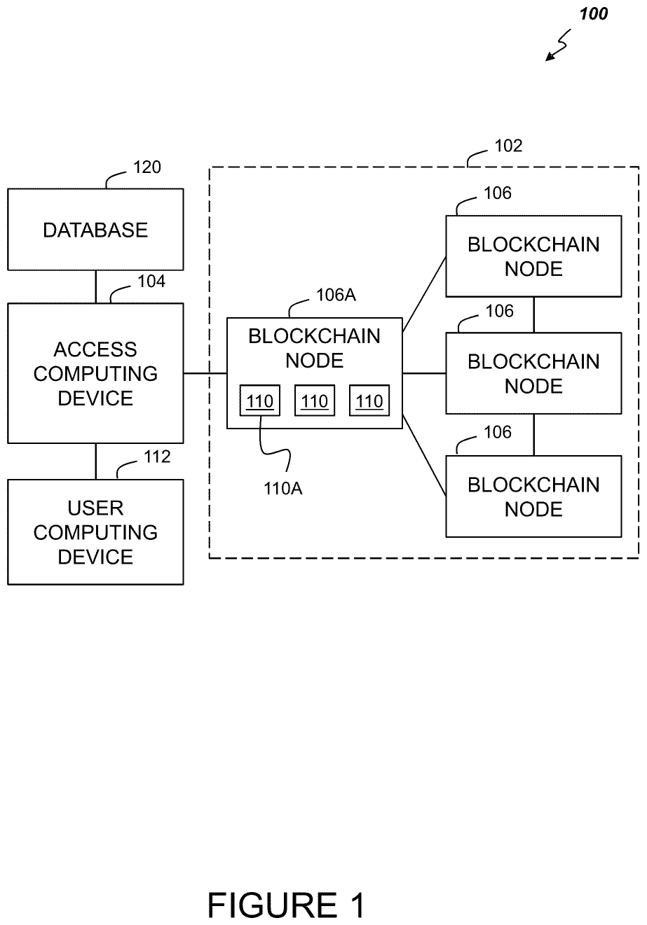

FIG. 1 depicts an exemplary computing environment 100 for implementing an PA computer system 102 for creating a blockchain that securely and accurately stores property development information. PA computer system 102 may be used to create a blockchain that securely and accurately stores property development information for a particular item that may be easily retrieved, viewed, and updated by multiple parties. In the exemplary embodiment, PA computer system 102 may include an access computing device 104 and at least one blockchain node computing device 106 (also referred to herein as “nodes” 106) of a blockchain network 108. Access computing device 104 is communicatively coupled, such as via wireless communication or data transmission over one or more radio frequency links or digital communication channels, or wired communication, or via an Application Programming Interface (API), to at least one node 106A, and node 106A is communicatively coupled to a plurality of other nodes 106B, such as via wireless communication or data transmission over one or more radio frequency links or digital communication channels, or wired communication. The plurality of nodes 106 may form blockchain network 108. Each node 106 may store a respective copy of a plurality of blockchains 110. As described further herein, each blockchain 110 may include a sequence of one or more blocks that are cryptographically verifiable and enforce a chronological order of data stored in subsequent blocks, and each block after a first block may include a description of data stored in a previous block and/or a link to the previous block.

As described herein in more detail, access computing device 104 may be configured to perform a property development information input process by, for example, (i) accessing blockchain network 108 through a first blockchain node computing device 106A, (ii) receiving a request to store information using a first blockchain 110A of the plurality of blockchains 110, the request including an asset identifier associated with a real estate property asset, (iii) transmitting new property development information associated with the real estate property asset, (iv) receiving a acceptance notification indicating acceptance of the new property development information, and/or (v) in response to receiving the acceptance notification, automatically transmitting an input instruction to first blockchain node computing device 106A, the input instruction including an encryption of the new property development information, the input instruction causing first blockchain node computing device 106A to generate and store a first block, the first block including the encryption of the new property development information.

In the exemplary embodiment, a customer may interact with access computing device 104 (e.g., directly or indirectly) to perform a property development information input process. For instance, the customer may interact with a website, form, software application (“app”), or other such platforms, to provide various information (e.g., user data, asset data, etc.) to an insurance provider and/or a third party using access computing device 104. Additionally, for instance, the customer may interact with a website, form, software application (“app”), or other such platforms, to receive various information (e.g., policy coverage, policy cost, build timeline, etc.) from an insurance provider using access computing device 104. Furthermore, for instance, the customer may interact with a website, form, software application (“app”), or other such platforms, to receive various information (e.g., material, cost, quantity, installation timeline, inventory management, etc.) from a third party (e.g., real estate contractor, real estate builder, hardware store, appliance store, etc.) using access computing device 104. In some embodiments, access computing device 104 may be associated with an insurance provider and/or a third party, such that a customer may interact with access computing device 104 at a location associated with the insurance provider (e.g., at an office location associated with the insurance provider) and/or the third party (e.g., at an office location associated with a real estate contact and/or at a store). Alternatively, access computing device 104 may be associated with the customer, such that the customer may interact with access computing device 104 at substantially any time and/or in any location. Additionally, or alternatively, a customer may use a user computing device 112 to remotely or indirectly interact with access computing device 104. For instance, the customer may use user computing device 112 to interact with a form on an app or a website, and user computing device 112 may be configured to transmit any input information to access computing device 104 for further processing as described herein.

Additionally, as described herein in more detail, access computing device 104 may be configured to perform a property development information maintenance process by, for example, (i) accessing blockchain network 108 through a first blockchain node computing device 106A, (ii) receiving a request for information from a first blockchain 110A of the plurality of blockchains 110, the request including an asset identifier associated with a real estate property asset, (iii) transmitting a query including the asset identifier to first blockchain node computing device 106A, the asset identifier identifying first blockchain 110A and causing first blockchain node computing device 106A to identify a last block in first blockchain 110A, the last block including an encryption of existing property development information associated with the real estate property asset, (iv) receiving the encryption of the existing property development information from the first blockchain node computing device, (v) accessing a public key to decrypt the encryption of the existing property development information, (vi) transmitting updated property development information associated with the real estate property asset based at least in part upon the decrypted existing property development information, the updated property development information superseding the existing property development information, (vii) receiving a acceptance notification indicating acceptance of the updated property development information, and/or (vii) in response to receiving the acceptance notification, automatically transmitting an update instruction to first blockchain node computing device 106A, the update instruction including an encryption of the updated property development information, the update instruction causing first blockchain node computing device 106A to generate and store a new block subsequent to the last block, the new block including the encryption of the updated property development information and a description of data stored in the last block.

In the exemplary embodiment, a customer may interact with access computing device 104 (e.g., directly or indirectly) to perform a property development information maintenance process. For instance, the customer may interact with a website, form, software application (“app”), or other such platforms, to provide various information (e.g., user data, asset data, etc.) to an insurance provider and/or a third party using access computing device 104. Additionally, for instance, the customer may interact with a website, form, software application (“app”), or other such platforms, to receive various information (e.g., policy coverage, policy cost, installation and/or repair timeline, etc.) from an insurance provider using access computing device 104. Furthermore, for instance, the customer may interact with a website, form, software application (“app”), or other such platforms, to receive various information (e.g., material, cost, quantity, installation and/or repair timeline, inventory management, etc.) from a third party (e.g., real estate contractor, real estate builder, hardware store, appliance store, repair technician, etc.) using access computing device 104. In some embodiments, access computing device 104 may be associated with an insurance provider and/or a third party, such that a customer may interact with access computing device 104 at a location associated with the insurance provider (e.g., at an office location associated with the insurance provider) and/or the third party (e.g., at an office location associated with a real estate contact and/or at a store). Alternatively, access computing device 104 may be associated with the customer, such that the customer may interact with access computing device 104 at substantially any time and/or in any location. Additionally or alternatively, a customer may use a user computing device 112 to remotely or indirectly interact with access computing device 104. For instance, the customer may use user computing device 112 to interact with a form on an app or a website, and user computing device 112 may be configured to transmit any input information to access computing device 104 for further processing as described herein.

Access computing device 104 and/or user computing device 112 may be computers that include a web browser or a software application, which enables access computing device 104 and/or user computing device 112 to access remote computer devices, such as node 106A, using the Internet or other network. More specifically, access computing device 104 and/or user computing device 112 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Access computing device 104 and/or user computing device 112 may be any device capable of accessing the Internet including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, voice bots, ChatGPT bots, and/or other web-based connectable equipment or mobile devices.

In addition, nodes 106 may be computers configured to communicate with one another, using the Internet or other network. More specifically, nodes 106 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. In some embodiments, nodes 106 may be any device capable of accessing the Internet including, but not limited to, a desktop computer, a laptop computer, a personal digital assistant (PDA), a cellular phone, a smartphone, a tablet, a phablet, wearable electronics, smart watch, mobile device, virtual headsets or glasses (e.g., AR (augmented reality), VR (virtual reality), or XR (extended reality) headsets or glasses), chat bots, voice bots, ChatGPT bots, and/or other web-based connectable equipment or mobile devices. In other embodiments, nodes 106 may be server computing devices specifically configured to function as blockchain nodes 106.

In some embodiments, access computing device 104 may function as node 106. Accordingly, where reference is made herein to access computing device 104 accessing and/or otherwise communicating with nodes 106 (e.g., with node 106A), it should be understood that such reference may equally refer to access computing device 104 accessing node functionality within access computing device 104 itself.

Access computer device 104 may be further communicatively coupled to a database 120 that stores data. For instance, database 120 may be a local or remote database 120 associated with an insurance provider and/or a third party, and configured to store data not stored in blockchain network 108 and/or store a local copy of certain data stored in blockchain network 108. In one embodiment, database 120 may store property development, user, asset, insurance, and/or property feature information associated with a real estate property asset associated with the insurance provider and/or the third party associated with access computer device 104, and/or any other suitable information. In one embodiment, database 120 may be stored remotely from access computing device 104. In some embodiments, database 120 may be decentralized. In some embodiments, a user, such as a customer and/or a person associated with a insurance provider and/or a third party, may access database 120 via access computing device 104 and/or another computing device (not shown) associated with the insurance provider and/or the third party.

In one exemplary embodiment of the present disclosure, a property archival

(PA) computer system (e.g., PA computer system 102) for creating a blockchain that securely and accurately stores property development information may include a first blockchain node computing device (e.g., node 106A) integral to a blockchain network (e.g., blockchain network 108). The blockchain network may include a plurality of blockchain node computing devices (e.g., nodes 106) including the first blockchain node computing device. The first blockchain node computing device may be configured to store a local copy of a plurality of blockchains (e.g., blockchains 110), each blockchain including a sequence of one or more blocks, wherein each block is cryptographically verifiable and enforces a chronological order of data stored in subsequent blocks. Each block after a first block may include a description of data stored in a previous block.

The PA computer system may also include an access computing device (e.g., access computing device 104) communicatively coupled to the first blockchain node computing device such that the access computing device has access to the plurality of blockchains stored in the blockchain network. The PA computer system may be configured to: receive, at the access computing device, a request to access the blockchain network, the request including an asset identifier associated with a real estate property asset, (ii) transmit, from the access computing device to the first blockchain node computing device, an instruction associated with the request, the instruction including the asset identifier, (iii) in response to receiving the query, at the first blockchain node computing device, when the asset identifier is associated with a first existing blockchain stored at the first blockchain node computing device, retrieve encrypted existing property development information from a last block of the first existing blockchain and transmit the encrypted existing loan information to the access computing device, and/or (iv) in response to receiving the query, at the first blockchain node computing device, when the asset identifier is not associated with any existing blockchain stored at the first blockchain node computing device, generate a first block of a new blockchain associated with the asset identifier.

In some embodiments, the request to access the blockchain network may include a new real estate property build request, the new real estate property build request including the asset identifier and new property development information associated with an upcoming build of a real estate property asset. New property development information may include, but is not limited to, building materials, building costs, property feature costs, real estate property asset values, material and/or property feature quantities, material and/or property feature newness data, material and/or property feature sources, real estate property location data, property build timeline data, and/or material and/or property feature install timeline data. The PA computer system may be further configured to, at the first blockchain node computing device, generate the first block of the new blockchain including the new property development information in an encrypted format.

In other embodiments, the request to access the blockchain network may include an update real estate property request, the update real estate property request including the asset identifier, existing property development information, and updated property development information associated with an upcoming development, repair, and/or rebuild of a real estate property asset. Updated property development information may include, but is not limited to, planned development data (e.g., materials, costs, sources, and timeline data associated with a planned development of the real estate property asset, such as building onto or renovating the real estate property asset), property damage data (e.g., location, personal property, insurance coverage, and cost data associated with repairing and/or rebuilding the real estate property asset). The PA computer system may be further configured to, at the first blockchain node computing device: (i) identify the first existing blockchain associated with the real estate property asset based at least in part upon the asset identifier, (ii) generate a hash of the last block of the first existing blockchain, and/or (iii) generate a new block for the first existing blockchain, the new block including the updated property development information in an encrypted format and the hash of the last block.

### Exemplary Processes for Managing Property Archival Information

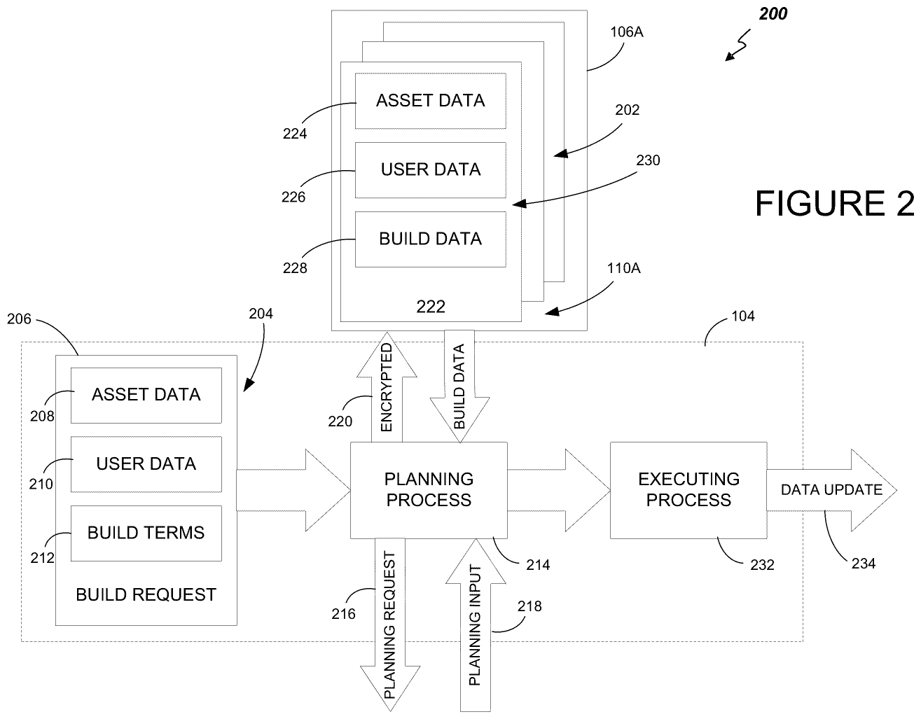

FIG. 2 illustrates a data flow diagram 200 for one aspect of managing property archival information using PA computer system 102 (shown in FIG. 1). Specifically, data flow diagram 200 depicts a property archival information input process using access computing device 104 and blockchain node computing device 106A (both also shown in FIG. 1).

In the exemplary embodiment, access computing device 104 may access node 106. As described above, node 106 may be part of blockchain network 108 (shown in FIG. 1) including a plurality of nodes 106 that each store a respective copy of a plurality of blockchains 110 (also shown in FIG. 1), and each blockchain 110 may include a sequence of one or more blocks 202 that are cryptographically verifiable and enforce a chronological order of data stored in subsequent blocks 202, wherein each block 202 after a first block (not specifically shown in FIG. 2) includes a description of data stored in a previous block 202 and/or a link to the previous block 202. The description of the data in the previous block 202 and/or the link to the previous block 202 may include, in the exemplary embodiment, a hash of the previous block 202 generating using a hash function.

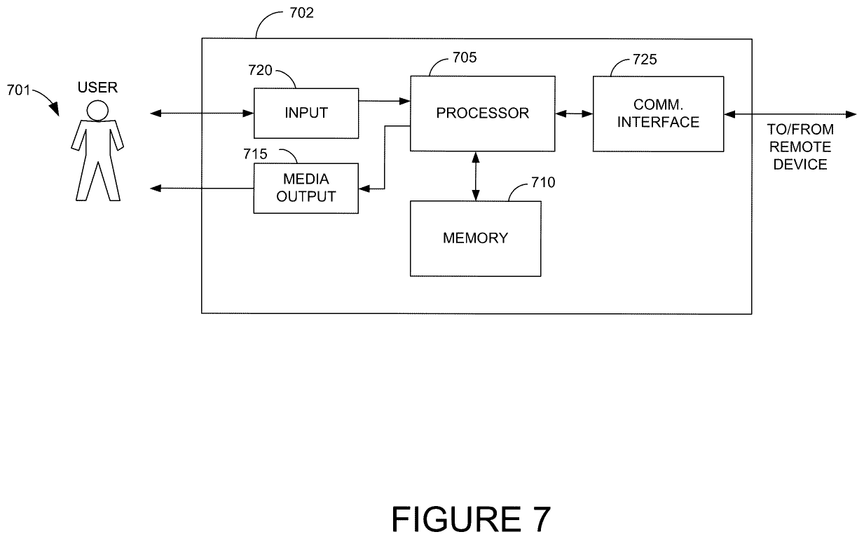

Access computing device 104 may receive a request 204 for information from a first blockchain 110A. First blockchain 110A is identified using information in request 204. More specifically, in the illustrated embodiment, request 204 may include a real estate property build request 206 associated with a new real estate property asset (e.g., a request to build a new real estate property). Access computing device 104 may receive request 204 (e.g., new real estate property build request 206) from a user computing device 112 (shown in FIG. 1) associated with a customer. Alternatively, access computing device 104 may receive request 204 (e.g., a request to build a new real estate property) from an input device of access computing device 104 (e.g., input device 720, shown in FIG. 7).

New real estate property build request 206 may include asset data 208 associated with the new real estate property asset for which the build is being requested. Asset data 208 may include, but is not limited to, an asset identifier that uniquely identifies the new real estate property asset. For example, the asset identifier may include an address or geographical coordinates of the real estate property. Asset data 208 may include additional and/or alternative information associated with the new real estate property asset.

New real estate property build request 206 may also include user data 210 (also referred to as “customer data”) associated with the customer building the new real estate property. For instance, user data 210 may include an identifier that uniquely identifies the customer (e.g., a Social Security Number (SSN)). In the exemplary embodiment, user data 210 may further include a consent indicator, indicating that the customer has provided their consent for the use and/or storage of user data 210 and/or asset data 208 for the purposes of the real estate property being built. In some embodiments, the consent indicator may be provided using a checkbox or radio button on an electronic form (e.g., within an app or website through which the customer is providing information for new real estate property build request 206).

New real estate property build request 206 may also include requested build terms 212. Build terms 212 may be selected, provided, and/or specified by the customer, and may include requested construction timelines, vendor selections, material selections, feature selections, interest rates, loan amounts, payment timelines, down payment options, and/or any other build terms 212. For example, build terms 212 may include, but is not limited to, property feature data that identifies property features (e.g., materials, hardware, appliances, and/or finishing features) to be used for building the new real estate property asset.

Access computing device 104 may proceed with a planning process 214 to plan a build for a new real estate property asset. Planning process 214 may include, but is not limited to, selecting and sourcing the materials, hardware, finishing features for the real estate property to be built. As part of planning process 214, access computing device 104 may submit planning requests 216 to third parties to request the needed information to complete the build plan for the new real estate property asset. For example, access computing device 104 may submit planning requests 216 to building contractors (e.g., to request costs and build timelines) and/or building supply stores (e.g., to request costs and inventory availability timelines). Additionally, as part of planning process 214, access computing device 104 may receive planning inputs 218 from third parties to collect the needed information to complete the build plan for the new real estate property asset. For example, access computing device 104 may receive planning inputs 218 from building contractors (e.g., to receive costs and build timelines) and/or building supply stores (e.g., to receive costs and inventory availability timelines).

Access computing device 104 may transmit an encrypted instruction 220 to node 106A. Encrypted instruction 220 may cause node 106A to generate a new block 222 in a blockchain 110 associated with the new real estate property asset. Encrypted instruction 220 may include asset data 208, such as an asset identifier, such that node 106A may identify blockchain 110A associated with the real estate property asset identified by asset data 208. As a result of encrypted instruction 220, new block 222 in blockchain 110 may include asset data 224 associated with the new real estate property asset (e.g., the asset identifier), user data 226 associated with the customer, and/or build data 228 describing the plan for the property build. Build data 228 may include, for example, build timelines, material costs and sources, feature costs and sources, and appliance costs and sources. User data 226 may include one or more elements similar to and/or matching elements of user data 210. In the exemplary embodiment, new property development information 230 may be encrypted.

Node 106A may respond to encrypted instruction 220 by transmitting at least some of the new property development information 230 to access computing device 104. For example, node 106A may transmit at least some of build data 228 to access computing device 104. In the exemplary embodiment, node 106A transmits new property development information 230 in an encrypted state to access computing device 104. Access computing device 104 may access a public key to decrypt the encrypted new property development information 230. In some embodiments, access computing device 104 may access the public key from node 106A. For instance, last block 222 may include a public key such that node 106A may provide the public key to access computing device 104 when responding to encrypted instruction 220. Alternatively, access computing device 104 may have the public key stored at a local storage location, such as database 120 (shown in FIG. 1). Access computing device 104 may use the accessed public key to decrypt new property development information 230 such that access computing device 104 may process new property development information 230.

Based at least in part upon new property development information, access computing device 104 may proceed with an executing process 232 to build the new real estate property asset. Executing process 232 may include, but is not limited to, communication with third parties associated with building and supplying the build of the new real estate property asset (e.g., final costs and build timelines, material and hardware quantities, appliance sourcing, etc.), creation and validation of documents required for the building process (e.g., building blueprints, contracts with third parties, build timelines, etc.), and/or communication with insurance providers associated with providing insurance coverage for the new real estate property asset (e.g., cost and quantity of property features for insurance coverage cost estimates). One example of an executing process 232 may including automatically transmitting an update instruction 234 to node 106A. Update instruction 234 may include existing property development information. Additionally, update instruction 234 may cause node 106A to generate and store a new block (not shown in FIG. 2) subsequent to last block 222, the new block including an encryption of the existing property development information and a description of data stored in the last block (e.g., a hash of last block 222).

Node 106A may generate any number of new blocks in accordance with received encrypted instructions. Node 106A may be further configured to distribute any generated blocks 202 to a plurality of nodes 106 within blockchain network 108, such that the plurality of nodes 106 update their respective stored copies of blockchain 110A. Moreover, node 106A may be configured to receive blocks 202 from any of the plurality of nodes 106 for any blockchain 110 and may update its own stored copy of those blockchain(s) 110 with the received blocks 202.

### Exemplary Processes for Managing Property Archival Information

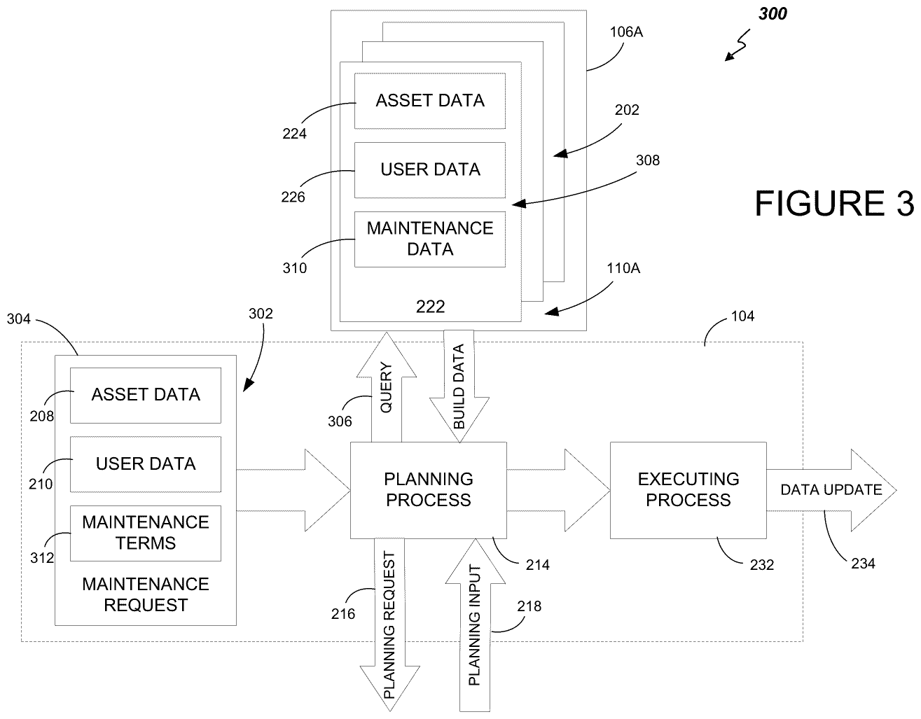

FIG. 3 illustrates a data flow diagram 300 for one aspect of managing property archival information using PA computer system 102 (shown in FIG. 1). Specifically, data flow diagram 300 depicts a property archival information input process using access computing device 104 and blockchain node computing device 106A (both also shown in FIG. 1). Data flow diagram 300, as shown in FIG. 3, is similar to data flow diagram 200, as shown in FIG. 2, with the differences as noted herein.

Access computing device 104 may receive a request 302 for information from a first blockchain 110A regarding an existing real estate property asset. First blockchain 110A is identified using information in request 302. More specifically, in the illustrated embodiment, request 302 may include a real estate property maintenance request 304 associated with a new real estate property asset (e.g., a request to build a new real estate property). Access computing device 104 may receive request 302 (e.g., real estate property maintenance request 304) from a user computing device 112 (shown in FIG. 1) associated with a customer. Alternatively, access computing device 104 may receive request 302 (e.g., a request to maintain an existing real estate property via development and/or repair) from an input device of access computing device 104 (e.g., input device 720, shown in FIG. 7).

Maintenance request 206 may include requested maintenance terms 312. Maintenance terms 312 may be selected, provided, and/or specified by the customer, and may include requested construction and/or repair timelines, vendor selections, material selections, feature selections, interest rates, loan amounts, payment timelines, down payment options, and/or any other, maintenance terms 312. For example, maintenance terms 312 may include, but is not limited to, property feature data that identifies property features (e.g., materials, hardware, appliances, and/or finishing features) to be used for developing and/or repairing the existing real estate property asset.

As part of planning process 214, access computing device 104 may transmit a query 306 to node 106A. Query 306 may include asset data 208, such as an asset identifier, such that node 106A may identify blockchain 110A associated with the real estate property asset identified by asset data 208. Query 306 may cause node 106A to identify blockchain 110A, specifically a last (or most recent) block 222 in blockchain 110A. Last block 222 may include existing property development information 308 describing the development history (e.g., new construction, repair, and/or maintenance history) of the existing real estate property asset. Existing property development information 308 may include, for example, maintenance data 310 describing the plan for the property maintenance. Maintenance data 310 may include, for example, development and/or repair timelines, material costs and sources, feature costs and sources, and appliance costs and sources. In the exemplary embodiment, existing property development information 308 may be encrypted.

### Exemplary Blockchain

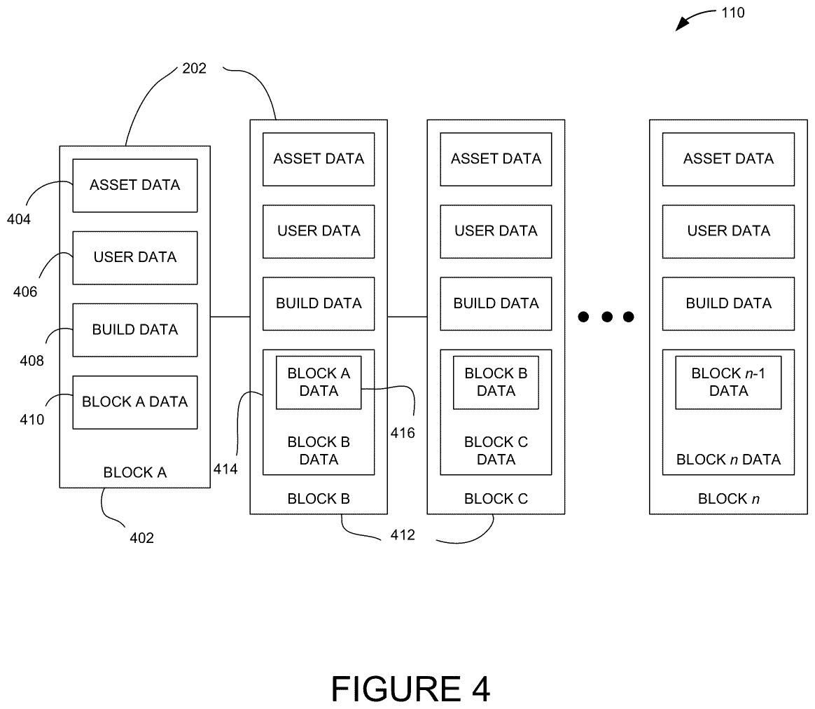

FIG. 4 depicts an exemplary blockchain 110 associated with a real estate property asset that may be generated and stored using one or more blockchain nodes 106 of a blockchain network 108 (all shown in FIG. 1). Blockchain network 108 may be a distributed database that maintains a continuously-growing blockchain 110, or list, of ordered records, known as blocks 202 (shown in FIG. 2). Blockchain network 108 may provide an encrypted, distributed, and immutable ledger as blockchains 110 in which property development information associated with a plurality of real estate property assets are stored. Each blockchain 110 includes a sequence of one or more blocks 202 that are cryptographically verifiable and enforce a chronological order of data stored in subsequent blocks 202.

In one exemplary embodiment, the one or more blocks 202 may include a first block 402 (referred to as “Block A” in FIG. 4) representing a first transaction-or a new real estate property build request-associated with a real estate property asset. In the exemplary embodiment, Block A may store asset data 404 identifying the real estate property asset, user data 406 identifying the customer building the real estate property asset, and/or build data 408, identifying the terms of the property build. Block A may further include Block A data 410 associated specifically with Block A. For instance, Block A data 410 may include a timestamp associated with the generation of Block A and/or an identifier of a node 106 at which Block A was generated.

The one or more blocks 202 may additionally include subsequent blocks 412 (referred to individually as “Block B,” “Block C,” through “Block n” in FIG. 4 and collectively as blocks 412). Each subsequent block 412 may include asset data 404, user data 406, and build data 408, any of which may be similar to or different from the data stored in Block A. For instance, each subsequent block 412 may include updates or changes to build data 408 according to updated property development information pertaining to the real estate property asset.

Each subsequent block 412 may also include block data 414 associated with that corresponding block 412. For subsequent blocks 412, block data 414 may not only include data associated specifically with that block 412 (e.g., timestamp, node 106 identifier) but may further include a description of the previous block 412′s data. As one specific example, Block B data 414 may include a description 416 of Block A, wherein description 416 may include a hash of Block A. The hash may be generated by executing a hashing function on the data 404, 406, 408, 410 stored in Block A. This continues on, with each block 412 adding on to the next while containing a hash of the previous block(s) 412 in blockchain 110. In this way, the chronological series of data stored in a single blockchain 110 may be verifiable and immutable.

### Exemplary System for Blockchain Mining

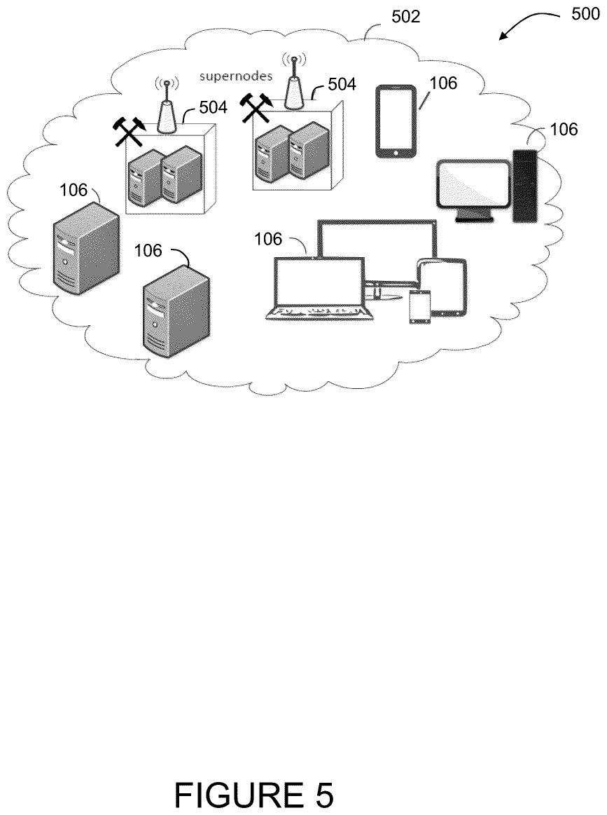

FIG. 5 illustrates a block diagram 500 of a blockchain mining system 502 in accordance with one embodiment of the present disclosure. Blockchain mining system 502 may be integral to and/or otherwise associated with blockchain network 108 (shown in FIG. 1). Blockchain mining system 502 may include a supernode 504 and a plurality of nodes 106 (shown in FIG. 1). Some nodes 106 may just be storing the latest copy of a blockchain 110 (shown in FIG. 1). Other nodes 106 may be miners and are processing blocks 202 (shown in FIG. 2) in blockchain 110. Supernode 504 monitors blockchain 110 and the integrity of system 502. For example, supernode 504 may monitor when different nodes 106 go offline or become unavailable. Supernode 504 may also add nodes 106 to system 502 and ensure that nodes 106 have up-to-date copies of blockchain 110. System 502 may include a plurality of nodes 106 from a plurality of sources to improve or increase the size and the integrity of each blockchain 110.

In some embodiments, nodes 106 may include one or more access computing device(s) 104 and/or one or more user computing device(s) 112 (shown in FIG. 1). Nodes 106 may additionally or alternatively include other computer devices of one or more loan providers. Nodes 106 may also include computer devices, such as servers, workstations, and mobile devices of a blockchain federation or network (e.g., blockchain network 108) that may extend outside of the control of the loan provider(s).

In some embodiments, a blockchain 110 may be maintained for each real estate property asset subject to build terms. In other embodiments, each customer and/or service provider associated with the real estate property asset maintains one or more blockchains 110, where each blockchain 110 contains the transactions from multiple real estate property assets associated with that customer and/or service provider.

When new property development information and/or updated property development information is registered at a node 106 (e.g., access computing device 104 transmits instructions to that node 106), the node 106 may wirelessly stream the data to be added to the corresponding blockchain 110. This data may be added to the appropriate blocks 202.

The data may be passed to the various other nodes 106 in system 502, where the data will be stored in blockchains 110 in each of the various nodes 106 storing the blockchain 110. In some embodiments, the data may be transferred and each node 106 generates the next block 202 in the blockchain 110. In other embodiments, the originating node 106 may generate the next block 202 and transmit the block 202 to the other nodes 106. In still other embodiments, supernode 504 may generate the next block 202 and transmit the block 202 to the nodes 106.

### Exemplary Computer-Implemented Processes for Managing Property Development Information Using Blockchains

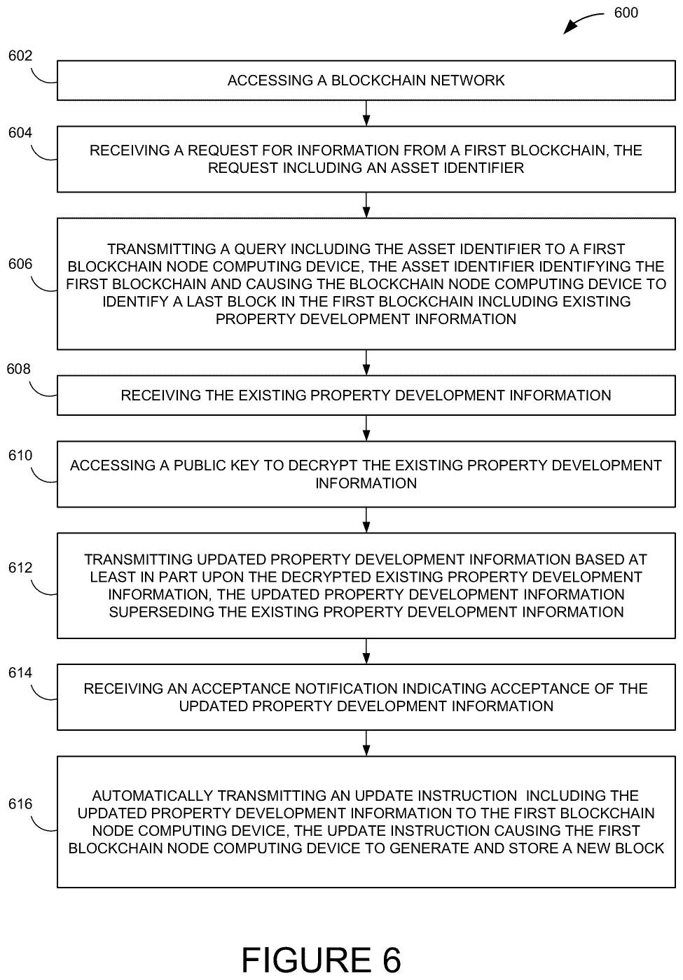

FIG. 6 illustrates a flow chart of an exemplary computer-implemented process 600 for one aspect of creating a blockchain that securely and accurately stores property development information using PA computer system 102 (shown in FIG. 1). One or more steps of process 600 may be implemented using access computing device 104 (also shown in FIG. 1). Additionally or alternatively, one or more steps of process 600 may be implemented using one or more nodes 106 and/or user computing device 112 (both also shown in FIG. 1).

In the exemplary embodiment, process 600 may include accessing 602 a blockchain network through a first blockchain node computing device. The blockchain network may include a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block. Process 600 may also include receiving 604 a request for information from a first blockchain of the plurality of blockchains, the request including an asset identifier associated with a real estate property asset. Process 600 may further include transmitting 606 a query including the asset identifier to the first blockchain node computing device, the asset identifier identifying the first blockchain and causing the blockchain node computing device to identify a last block in the first blockchain, the last block including an encryption of existing property development information for an existing real estate property asset.

In addition, process 600 may include receiving 608 the encryption of the existing property development information from the first blockchain node computing device and accessing 610 a public key to decrypt the encryption of the existing property development information. Process 600 may further include transmitting 612 updated property development information associated with the real estate property asset based at least in part upon the decrypted existing property development information, the updated property development information superseding the existing property development information, and receiving 614 an acceptance notification indicating acceptance of the updated property development information. Process 600 may still further include, in response to receiving 614, automatically transmitting 616 an update instruction to the first blockchain node computing device, the update instruction including the updated property development information, the update instruction causing the first blockchain node computing device to generate and store a new block subsequent to the last block, the new block including an encryption of the updated property development information and a description of data stored in the last block. Process 600 may include additional, fewer, and/or alternative steps to those illustrated in FIG. 6.

### Exemplary User Computer Device

FIG. 7 illustrates an exemplary configuration of a user computer device 702 that may be used in PA computer system 102 (shown in FIG. 1). User computer device 702 may be operated by a user 701. User computer device 702 may include, but is not limited to, access computing device 104, blockchain node computing device(s) 106, and/or user computing device 112 (all shown in FIG. 1). User computer device 702 may include a processor 705 for executing instructions. In some embodiments, executable instructions may be stored in a memory area 710. Processor 705 may include one or more processing units (e.g., in a multi-core configuration). Memory area 710 may be any device allowing information such as executable instructions and/or transaction data to be stored and retrieved. Memory area 710 may include one or more computer readable media.

User computer device 702 may also include at least one media output component 715 for presenting information to user 701. Media output component 715 may be any component capable of conveying information to user 701. In some embodiments, media output component 715 may include an output adapter (not shown) such as a video adapter and/or an audio adapter. An output adapter may be operatively coupled to processor 705 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 715 may be configured to present a graphical user interface (e.g., a web browser and/or a client application) to user 701. A graphical user interface may include, for example, a fillable form to provide one or more of asset data 208, user data 210, and/or build terms 212 (shown in FIG. 2). In some embodiments, user computer device 702 may include an input device 720 for receiving input from user 701. User 701 may use input device 720 to, without limitation, provide one or more of asset data 208, user data 210, and/or build terms 212, access the planning process 214 (also shown in FIG. 2) for a new real estate property build request, and/or access the executing process 232 (also shown in FIG. 2). Input device 720 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 715 and input device 720.

Stored in memory area 710 are, for example, computer readable instructions for providing a user interface to user 701 via media output component 715 and, optionally, receiving and processing input from input device 720. A user interface may include, among other possibilities, a web browser and/or a client application. Web browsers enable users, such as user 701, to display and interact with media and other information typically embedded on a web page or a website from, for example, a service provider associated with building a real estate property asset (e.g., an insurance provider, a property builder, etc.). A client application may allow user 701 to interact with, for example, access computing device 104 and/or node(s) 106. For example, instructions may be stored by a cloud service, and the output of the execution of the instructions sent to the media output component 715.

User computer device 702 may also include a communication interface 725, communicatively coupled to a remote device such as access computing device 104, and/or node(s) 106. Communication interface 725 may include, for example, a wired or wireless network adapter and/or a wireless data transceiver for use with a mobile telecommunications network.

### Exemplary Server Computer Device

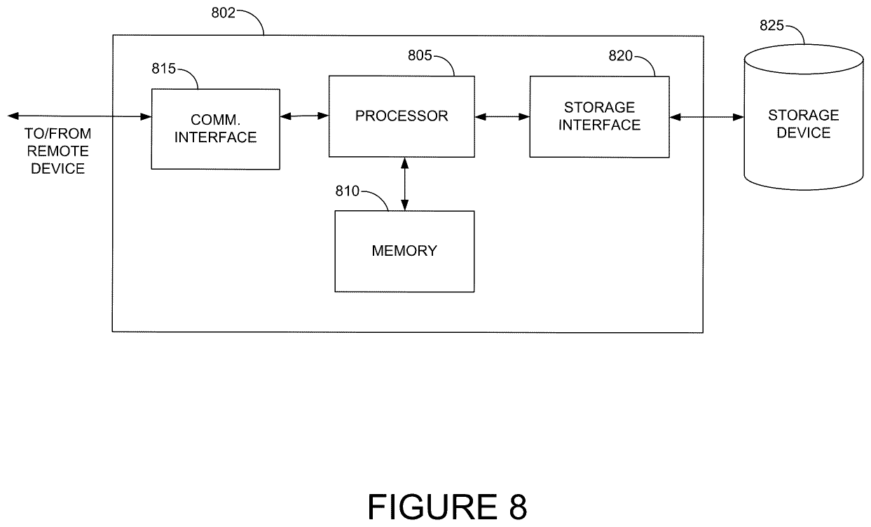

FIG. 8 illustrates an exemplary configuration of a server computer device 802 that may be used in PA computer system 102 (shown in FIG. 1). Server computer device 802 may include, but is not limited to, access computing device 104 and/or node(s) 106 (both also shown in FIG. 1). Server computer device 802 may include a processor 805 for executing instructions. Instructions may be stored in a memory area 810. Processor 805 may include one or more processing units (e.g., in a multi-core configuration).

Processor 805 may be operatively coupled to a communication interface 815 such that server computer device 802 is capable of communicating with a remote device such as another server computer device 802, a user computer device 702 (shown in FIG. 7), user computing device 112 (shown in FIG. 1), access computing device 104, and/or node(s) 106 (for example, using wireless communication or data transmission over one or more radio links or digital communication channels). For example, communication interface 815 may receive requests from user computer devices 702 via the Internet.

Processor 805 may also be operatively coupled to a storage device 825. Storage device 825 may be any computer-operated hardware suitable for storing and/or retrieving data, such as, but not limited to, data associated with database 120 (shown in FIG. 1). In some embodiments, storage device 825 may be integrated in server computer device 802. For example, server computer device 802 may include one or more hard disk drives as storage device 825. In other embodiments, storage device 825 may be external to server computer device 802 and may be accessed by a plurality of server computer devices 802. For example, storage device 825 may include a storage area network (SAN), a network attached storage (NAS) system, and/or multiple storage units such as hard disks and/or solid state disks in a redundant array of inexpensive disks (RAID) configuration.

In some embodiments, processor 805 may be operatively coupled to storage device 825 via a storage interface 820. Storage interface 820 may be any component capable of providing processor 805 with access to storage device 825. Storage interface 820 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 805 with access to storage device 825.

Processor 805 may execute computer-executable instructions for implementing aspects of the disclosure. In some embodiments, the processor 805 may be transformed into a special purpose microprocessor by executing computer-executable instructions or by otherwise being programmed. For example, the processor 805 may be programmed with the instruction such as illustrated in FIG. 6.

### Exemplary Computer Device

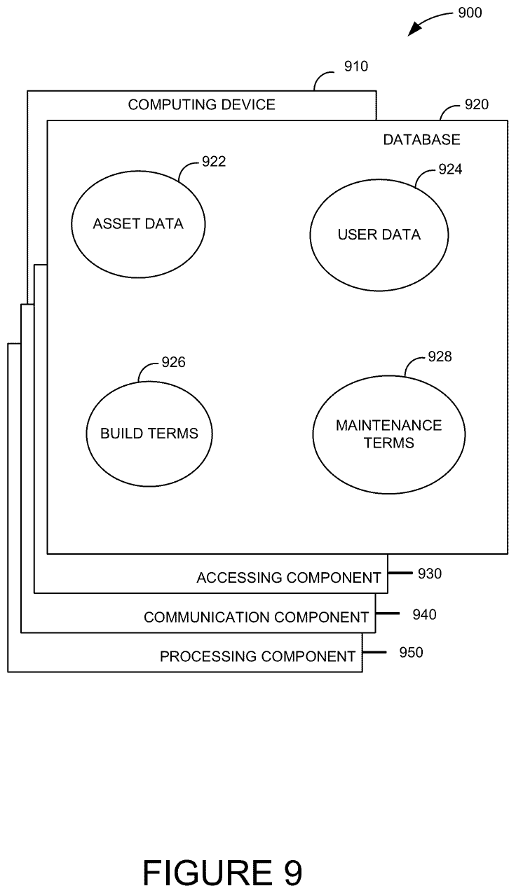

FIG. 9 depicts a diagram 900 of components of one or more exemplary computing devices 910 that may be used in PA computer system 102 (shown in FIG. 1). In some embodiments, computing device 910 may be similar to access computing device 104 (also shown in FIG. 1). In other embodiments, computing device 910 may be similar to node(s) 106 and/or user computing device 112 (both also shown in FIG. 1). In the exemplary embodiment, computing device 910 may include a database 920 for storing information. For example, database 920 may store asset data 922, user data 924, build terms 926, maintenance terms 928, and/or any other data associated with one or more builds of a real estate property asset. In some embodiments, database 920 is similar to database 120 (shown in FIG. 1).

Database 920 may be coupled with several separate components within computing device 910, which perform specific tasks. Specifically, computing device 910 may include an accessing component 930 enabling access to remote computing devices (e.g., nodes 106). Computing device 910 may also including a communication component 940, for . . . [method claim verbiage from FIG. 6]. Computing device 910 may further include a processing component 950 to assist with execution of computer-executable instructions associated with PA computer system 102.

### Further Considerations

Building the solution to the above-referenced problems with current property development information management systems through blockchain technology may eliminate the need for a third-party data provider and may be more secure due to decentralization and encryption. In addition, the systems and methods described herein may provide seamless property development information transmission between customers, insurance providers, and third parties, facilitated by the distributed computing architecture of the blockchain network. Moreover, technology could support expansion into other inter-institution processes like funds transfer, document validation, and document exchange.

The systems and methods described herein may improve the ability of a service provider associated with a real estate property asset to provide better customer experience at a lower cost. It may provide a base layer (e.g., a functional blockchain and ability to execute smart contracts) to scale seamless data exchange between customers, insurance providers, and third parties. In addition to the blockchain techniques described herein, alternative and/or future developed blockchain techniques may be used with the present embodiments.

### Exemplary Embodiments

In one aspect, a computer-implemented method may be provided. The computer-implemented method may be performed by a computer device including at least one processor in communication with at least one memory device. The method may include: (1) accessing a blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block; (2) receiving a request for information from a first blockchain of the plurality of blockchains, the request including an asset identifier associated with a real estate property asset; (3) transmitting a query including the asset identifier to the first blockchain node computing device, the asset identifier identifying the first blockchain and causing the first blockchain node computing device to identify a last block in the first blockchain, the last block including an encryption of property management information for maintenance of an existing real estate property asset; (4) receiving the encryption of the property development information from the first blockchain node computing device; (5) accessing a public key to decrypt the encryption of the property development information; (6) transmitting updated property development information for an existing real estate property asset based at least in part upon the decrypted existing property development information, the updated property development information superseding the property development information; (7) receiving an acceptance notification indicating acceptance of the updated property development information; and/or (8) in response to said receiving the acceptance notification, automatically transmitting an update instruction to the first blockchain node computing device, the update instruction including the updated property development information, the update instruction causing the first blockchain node computing device to generate and store a new block subsequent to the last block, the new block including an encryption of the updated property development information and a description of data stored in the last block. The computer-implemented method may include additional, less, or alternate actions, including those discussed elsewhere herein.

An enhancement of the method may include receiving a request for information comprises receiving the request for information from a customer requesting to build a new real estate property asset. The enhancement of the method may further include receiving a request for information comprises receiving a new real estate property build request associated with building the new real estate property asset. Where receiving the new real estate property build request, the enhancement of the method may also include at least one of asset data associated with the new real estate property asset, customer data, and requested build terms associated with building the new real estate property asset.

An enhancement of the computer-implemented method may include where receiving a request for information further includes receiving the request for information from a customer requesting to maintain an existing real estate property asset, wherein maintaining the real estate property asset comprises one of developing the existing real estate property asset and repairing the existing real estate property asset. The enhancement of the method may further include receiving a request for information comprises receiving an update real estate property request associated with maintaining the existing real estate property asset. Where receiving the update real estate property request further includes at least one of asset data associated with the real estate property asset, customer data, and requested maintenance terms associated with maintaining the existing real estate property asset.

An enhancement of the computer-implemented method may include accessing a public key comprises accessing the public key from the first blockchain node computing device.

An enhancement of the computer-implemented method may include accessing a public key comprises accessing the public key from a local storage device associated with the access computing device.

An enhancement of the computer-implemented method may include encrypting the updated property development information prior to automatically transmitting an update instruction.

An enhancement of the computer-implemented method may include where automatically transmitting an update instruction to the first blockchain node computing device includes transmitting the update instruction including the updated property development information in an unencrypted format, the update instruction further causing the first blockchain node computing device to encrypt the updated property development information.

An enhancement of the computer-implemented method may include receiving an update to the updated property development information. In response to receiving an update, the enhancement of the computer-implemented method may include transmitting a subsequent update instruction to the first blockchain node computing device, the subsequent update instruction causing the first blockchain node computing device to generate a subsequent new block in the first blockchain, the subsequent new block including the update to the updated property development information.

An enhancement of the computer-implemented method may include receiving a plurality of data associated with the real estate property asset. The enhancement of the computer-implemented method may also include generating a container file for the real estate property asset to include the plurality of data. The enhancement of the computer-implemented method may further include generating a non-fungible token (NFT) for the real estate property asset based upon the container file. The enhancement of the computer-implemented method may also include storing the NFT and the container file for the real estate property asset.

An enhancement of the computer-implemented method may include retrieving the NFT to access the plurality of data associated with the real estate property asset. The enhancement of the computer-implemented method may also include inputting the plurality of data to an altered reality technology. In the enhancement, the altered reality technology may include one of augmented reality technology and virtual reality technology.

In another aspect, a Property Archival (PA) computer device may be provided. The PA computing device may include at least one processor in communication with at least one memory device. The PA computer device may be in communication with a user computer device associated with a user. The at least one processor may be configured to: (1) access a blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block; (2) receive a request for information from a first blockchain of the plurality of blockchains, the request including an asset identifier associated with a real estate property asset; (3) transmit a query including the asset identifier to the first blockchain node computing device, the asset identifier identifying the first blockchain and causing the first blockchain node computing device to identify a last block in the first blockchain, the last block including an encryption of property management information for maintenance of an existing real estate property asset; (4) receive the encryption of the property development information from the first blockchain node computing device; (5) access a public key to decrypt the encryption of the property development information; (6) transmit updated property development information for an existing real estate property asset based at least in part upon the decrypted existing property development information, the updated property development information superseding the property development information; (7) receive an acceptance notification indicating acceptance of the updated property development information; and/or (8) in response to said receiving the acceptance notification, automatically transmit an update instruction to the first blockchain node computing device, the update instruction including the updated property development information, the update instruction causing the first blockchain node computing device to generate and store a new block subsequent to the last block, the new block including an encryption of the updated property development information and a description of data stored in the last block. The SA computing device may include additional, less, or alternate functionality, including that discussed elsewhere herein.

An enhancement of the PA computing device may include a processor configured to receive the request for information from a customer requesting to build a new real estate property asset. The enhancement of the PA computing device may also include a processor configured to receive a new real estate property build request associated with building the new real estate property asset. Where the new real estate property build request further includes at least one of asset data associated with the new real estate property asset, customer data, and requested build terms associated with building the new real estate property asset.

A further enhancement of the PA computing device may include a processor configured to receive the request for information from a customer requesting to maintain an existing real estate property asset, wherein maintaining the real estate property asset comprises one of developing the existing real estate property asset and repairing the existing real estate property asset. The enhancement of the PA computing device may also include a processor configured to receive an update real estate property request associated with maintaining the existing real estate property asset. Where the update real estate property request further includes at least one of asset data associated with the real estate property asset, customer data, and requested maintenance terms associated with maintaining the existing real estate property asset.

A further enhancement of the PA computing device may include a processor configured to access the public key from the first blockchain node computing device.

A further enhancement of the PA computing device may include a processor configured to access the public key from a local storage device associated with the access computing device.

A further enhancement of the PA computing device may include a processor configured to encrypt the updated property development information prior to automatically transmitting an update instruction.

A further enhancement of the PA computing device may include a processor configured to transmit the update instruction including the updated property development information in an unencrypted format, the update instruction further causing the first blockchain node computing device to encrypt the updated property development information.

A further enhancement of the PA computing device may include a processor configured to receive an update to the updated property development information. In response to said receiving an update, the enhancement of the PA computing device may also include a processor configured to transmit a subsequent update instruction to the first blockchain node computing device, the subsequent update instruction causing the first blockchain node computing device to generate a subsequent new block in the first blockchain, the subsequent new block including the update to the updated property development information.

A further enhancement of the PA computing device may include a processor configured to receive a plurality of data associated with the real estate property asset. The enhancement of the PA computing device may also include a processor configured to generate a container file for the real estate property asset to include the plurality of data. The enhancement of the PA computing device may further include a processor configured to generate a non-fungible token (NFT) for the real estate property asset based upon the container file. The enhancement of the PA computing device may also include a processor configured to store the NFT and the container file for the real estate property asset.

A further enhancement of the PA computing device may include a processor configured to retrieve the NFT to access the plurality of data associated with the real estate property asset. The enhancement of the PA computing device may also include a processor configured to input the plurality of data to an altered reality technology. Where the altered reality technology includes one of augmented reality technology and virtual reality technology.

In another aspect, at least one non-transitory computer-readable media having computer-executable instructions embodied thereon may be provided. When executed by a computing device including at least one processor in communication with at least one memory device, the computer-executable instructions may cause the at least one processor to: (1) access a blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block; (2) receive a request for information from a first blockchain of the plurality of blockchains, the request including an asset identifier associated with a real estate property asset; (3) transmit a query including the asset identifier to the first blockchain node computing device, the asset identifier identifying the first blockchain and causing the first blockchain node computing device to identify a last block in the first blockchain, the last block including an encryption of property management information for maintenance of an existing real estate property asset; (4) receive the encryption of property development information from the first blockchain node computing device; (5) access a public key to decrypt the encryption of property development information; (6) transmit updated property development information for an existing real estate property asset based at least in part upon the decrypted existing property development information, the updated property development information superseding the property development information; (7) receive an acceptance notification indicating acceptance of the updated property development information; and/or in response to said receiving the acceptance notification, automatically transmit an update instruction to the first blockchain node computing device, the update instruction including the updated property development information, the update instruction causing the first blockchain node computing device to generate and store a new block subsequent to the last block, the new block including an encryption of the updated property development information and a description of data stored in the last block. The computer-executable instructions may direct additional, less, or alternate functionality, including that discussed elsewhere herein.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples are not intended to limit in any way the definition and/or meaning of the term database. Examples of RDBMS's include, but are not limited to, Oracle® Database, NoSQL, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an exemplary embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “exemplary embodiment” or “one embodiment” of the present disclosure are not intended to be interpreted as excluding the existence of additional embodiments that also incorporate the recited features.

Disjunctive language such as the phrase “at least one of X, Y, or Z,” unless specifically stated otherwise, is generally understood within the context as used to state that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer-implemented method of operating a computer system to manage property development information using blockchains, the method implemented using an access computing device of the computer system, the method comprising:
accessing a blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block;
receiving a request for information from a first blockchain of the plurality of blockchains, the request including an asset identifier associated with a real estate property asset;
transmitting a query including the asset identifier to the first blockchain node computing device, the asset identifier identifying the first blockchain and causing the first blockchain node computing device to identify a last block in the first blockchain, the last block including an encryption of property management information for maintenance of an existing real estate property asset;
receiving the encryption of the property development information from the first blockchain node computing device;
accessing a public key to decrypt the encryption of the property development information;
transmitting updated property development information for an existing real estate property asset based at least in part upon the decrypted existing property development information, the updated property development information superseding the property development information;
receiving an acceptance notification indicating acceptance of the updated property development information; and
in response to said receiving the acceptance notification, automatically transmitting an update instruction to the first blockchain node computing device, the update instruction including the updated property development information, the update instruction causing the first blockchain node computing device to generate and store a new block subsequent to the last block, the new block including an encryption of the updated property development information and a description of data stored in the last block.

2. The computer-implemented method of claim 1, wherein said receiving a request for information comprises receiving the request for information from a customer requesting to build a new real estate property asset.

3. The computer-implemented method of claim 2, wherein said receiving a request for information comprises receiving a new real estate property build request associated with building the new real estate property asset.

4. The computer-implemented method of claim 3, wherein receiving the new real estate property build request further comprises at least one of asset data associated with the new real estate property asset, customer data, and requested build terms associated with building the new real estate property asset.

5. The computer-implemented method of claim 1, wherein said receiving a request for information comprises receiving the request for information from a customer requesting to maintain an existing real estate property asset, wherein maintaining the real estate property asset comprises one of developing the existing real estate property asset and repairing the existing real estate property asset.

6. The computer-implemented method of claim 5, wherein said receiving a request for information comprises receiving an update real estate property request associated with maintaining the existing real estate property asset.

7. The computer-implemented method of claim 6, wherein receiving the update real estate property request further comprises at least one of asset data associated with the real estate property asset, customer data, and requested maintenance terms associated with maintaining the existing real estate property asset.

8. The computer-implemented method of claim 1, wherein accessing a public key comprises accessing the public key from the first blockchain node computing device.

9. The computer-implemented method of claim 1, wherein accessing a public key comprises accessing the public key from a local storage device associated with the access computing device.

10. The computer-implemented method of claim 1 further comprising encrypting the updated property development information prior to automatically transmitting an update instruction.

11. The computer-implemented method of claim 1, wherein automatically transmitting an update instruction to the first blockchain node computing device comprises transmitting the update instruction including the updated property development information in an unencrypted format, the update instruction further causing the first blockchain node computing device to encrypt the updated property development information.

12. The computer-implemented method of claim 1 further comprising:
receiving an update to the updated property development information; and
in response to said receiving an update, transmitting a subsequent update instruction to the first blockchain node computing device, the subsequent update instruction causing the first blockchain node computing device to generate a subsequent new block in the first blockchain, the subsequent new block including the update to the updated property development information.

13. The computer-implemented method of claim 1 further comprising:
receiving a plurality of data associated with the real estate property asset;
generating a container file for the real estate property asset to include the plurality of data;
generating a non-fungible token (NFT) for the real estate property asset based upon the container file; and
storing the NFT and the container file for the real estate property asset.

14. The computer-implemented method of claim 13, further comprising:
retrieving the NFT to access the plurality of data associated with the real estate property asset; and
inputting the plurality of data to an altered reality technology.

15. The computer-implemented method of claim 14, wherein the altered reality technology comprises one of augmented reality technology and virtual reality technology.

16. An access computing device for creating a blockchain that securely and accurately stores property development information, the access computing device comprising at least one processor in communication with a memory device, the at least one processor programmed to:
access a blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block;
receive a request for information from a first blockchain of the plurality of blockchains, the request including an asset identifier associated with a real estate property asset;
transmit a query including the asset identifier to the first blockchain node computing device, the asset identifier identifying the first blockchain and causing the first blockchain node computing device to identify a last block in the first blockchain, the last block including an encryption of property management information for maintenance of an existing real estate property asset;
receive the encryption of the property development information from the first blockchain node computing device;
access a public key to decrypt the encryption of the property development information;
transmit updated property development information for an existing real estate property asset based at least in part upon the decrypted existing property development information, the updated property development information superseding the property development information;
receive an acceptance notification indicating acceptance of the updated property development information; and
in response to said receiving the acceptance notification, automatically transmit an update instruction to the first blockchain node computing device, the update instruction including the updated property development information, the update instruction causing the first blockchain node computing device to generate and store a new block subsequent to the last block, the new block including an encryption of the updated property development information and a description of data stored in the last block.

17. The access computing device of claim 16, wherein the at least one processor is further programmed to receive the request for information from a customer requesting to build a new real estate property asset.

18. The access computing device of claim 17, wherein the at least one processor is further programmed to receive a new real estate property build request associated with building the new real estate property asset.

19. The access computing device of claim 18, wherein the new real estate property build request further comprises at least one of asset data associated with the new real estate property asset, customer data, and requested build terms associated with building the new real estate property asset.

20. At least one non-transitory computer-readable storage medium having computer-executable instructions embodied thereon, when executed by a user analytics computing device having at least one processor in communication with at least one memory, the computer-executable instructions cause the at least one processor to:
access a blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block;
receive a request for information from a first blockchain of the plurality of blockchains, the request including an asset identifier associated with a real estate property asset;
transmit a query including the asset identifier to the first blockchain node computing device, the asset identifier identifying the first blockchain and causing the first blockchain node computing device to identify a last block in the first blockchain, the last block including an encryption of property management information for maintenance of an existing real estate property asset;
receive the encryption of property development information from the first blockchain node computing device;
access a public key to decrypt the encryption of property development information;
transmit updated property development information for an existing real estate property asset based at least in part upon the decrypted existing property development information, the updated property development information superseding the property development information;
receive an acceptance notification indicating acceptance of the updated property development information; and
in response to said receiving the acceptance notification, automatically transmit an update instruction to the first blockchain node computing device, the update instruction including the updated property development information, the update instruction causing the first blockchain node computing device to generate and store a new block subsequent to the last block, the new block including an encryption of the updated property development information and a description of data stored in the last block.
